(19) United States
(12) Patent Application Publication
(10) Pub. No.: US 2026/0279235 A1
(43) Pub. Date: Sep. 17, 2026

(54) DISPLAY APPARATUS AND CONTROL METHOD THEREFOR

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventor: Jeunghie CHOE, Beijing (CN)

(21) Appl. No.: 19/469,358

(22) PCT Filed: May 17, 2024
(86) PCT No.: PCT/CN2024/093948

§ 371 Date: Sep. 25, 2025

(30) Foreign Application Priority Data
Jun. 2, 2023 (CN) 202310653636.5

(51) Int. Cl. G09G 3/00; G09G 3/3275

(52) U.S. Cl. CPC G09G 3/006; G09G 3/3275; G09G 2300/0842; G09G 2310/027; G09G 2310/0286; G09G 2310/0291; G09G 2330/08; G09G 2330/12

(57) ABSTRACT

A display apparatus and a control method therefor. The display apparatus comprises a display panel and a source driver located on at least one side of the display panel. The display panel is provided with sub-pixels arranged in an array and a plurality of data signal lines, and the sub-pixels are electrically connected to the data signal lines. The display apparatus further comprises a repair module and a plurality of data signal transmission lines. Some of the data signal transmission lines are broken. The data signal transmission lines are electrically connected to the source drivers and the data signal lines, respectively. The repair module is electrically connected to the data signal lines connected to the broken data signal transmission lines and is configured to transmit data signals to the data signal lines connected to the broken data signal transmission lines.

### CROSS-REFERENCE TO RELATED APPLICATIONS

This application is a U.S. National Phase Entry of International Application No. PCT/CN 2024/093948 having an international filing date of May 17, 2024, which claims priority to Chinese Patent Application No. 202310653636.5, filed to the CNIPA on Jun. 2, 2023 and entitled “Display Apparatus and Control Method Therefor”, the above-identified applications are incorporated into the present application by reference in their entireties.

### TECHNICAL FIELD

The present disclosure relates to, but is not limited to, the field of display technologies, and in particular to a display apparatus and a control method therefor.

### BACKGROUND

As two common types of displays in the market, a Liquid Crystal Display (LCD) apparatus has characteristics such as small volume, low power consumption, and no radiation, and an Organic Light Emitting Diode (OLED for short) and a Quantum-dot Light Emitting Diode (QLED for short) are active light emitting display devices and have advantages such as self-luminescence, a wide viewing angle, a high contrast ratio, low power consumption, an extremely high response speed, lightness and thinness, flexibility, and low cost. The two types of display devices can be applied in different scenarios due to their different advantages. The above two types of displays are usually connected to a printed circuit board and a display panel through a chip on film (COF for short).

### SUMMARY

The following is a summary of subject matters described herein in detail. This summary is not intended to limit the protection scope of claims.

In a first aspect, the present disclosure provides a display apparatus including a display panel and a source driver located on at least one side of the display panel. The display panel is provided with sub-pixels arranged in an array and a plurality of data signal lines, and the sub-pixels are electrically connected to the data signal lines. The display apparatus further includes a repair module and a plurality of data signal transmission lines, some of the data signal transmission lines are broken, and extension directions of the data signal transmission lines are the same as extension directions of the data signal lines.

The data signal transmission lines are electrically connected to the source driver and the data signal lines respectively.

The source driver is electrically connected to an unbroken data signal transmission line, and is configured to provide a data signal to the unbroken data signal transmission line.

The repair module is electrically connected to a data signal line to which a broken data signal transmission line is connected, and is configured to provide a data signal to the data signal line to which the broken data signal transmission line is connected.

In an exemplary implementation mode, when the display apparatus includes a chip on film, the source driver is disposed on the chip on film.

The repair module is disposed on at least one of the display panel and the chip on film, and the data signal transmission lines are disposed on the display panel and the chip on film.

In an exemplary implementation mode, the source driver includes a data processing circuit and a plurality of signal output circuits. A signal output circuit of the plurality of signal output circuits includes a shift register, a data latch circuit, a level conversion circuit, a digital-to-analog conversion circuit, and an output buffer circuit.

The data processing circuit is configured to preprocess received image data.

The shift register is electrically connected to the data processing circuit and is configured to sample and output preprocessed image data to generate a first data signal.

The data latch circuit is electrically connected to the shift register and is configured to latch the first data signal and output a second data signal.

The level conversion circuit is electrically connected to the data latch circuit and is configured to convert the second data signal to a third data signal, and a level of the third data signal is greater than a level of the second data signal.

The digital-to-analog conversion circuit is configured to convert the third data signal into a data signal, the third data signal is a digital signal and the data signal is an analog signal.

The output buffer circuit is electrically connected to the digital-to-analog conversion circuit and a data signal transmission line of the data signal transmission lines, and is configured to send the data signal to the unbroken data signal transmission line.

The shift register includes at least one shift register unit, and when the shift register includes a plurality of shift register units, the plurality of shift register units located in a same shift register are cascaded with each other.

The plurality of data signal transmission lines and the plurality of data signal lines are in a one-to-one correspondence relationship, and the number of shift register units in the signal output circuit is the same as the number of data signal transmission lines connected to the signal output circuit, and there is a one-to-one correspondence relationship between the shift register units in the signal output circuit and the data signal transmission lines connected to the signal output circuit.

In an exemplary implementation mode, the display apparatus further includes a memory. The memory is configured to store a set of defect identifications, the set of defect identifications includes an identification of a shift register unit electrically connected to the broken data signal transmission line, and the identification includes a serial number of the shift register unit or an address of the shift register unit.

In an exemplary implementation mode, the repair module includes at least one repair output circuit, at least one repair signal transmission line, and at least one repair signal connection line. An extension direction of the repair signal transmission line intersects with an extension direction of the repair signal connection line, there is a one-to-one correspondence relationship between the repair signal transmission line and the repair signal connection line, and the extension direction of the repair signal transmission line is the same as the extension directions of the data signal transmission lines.

The data processing circuit is configured to acquire a set of defect identifications stored in advance, and determine whether an identification of a shift register unit by which image data is to be sent is located in the set of defect identifications stored in advance. When the identification of the shift register unit by which the image data is to be sent is not located in the set of defect identifications stored in advance, the data processing circuit sends preprocessed image data to the shift register unit. When the identification of the shift register unit by which the image data is to be sent is located in the set of defect identifications stored in advance, the data processing circuit sends preprocessed repair image data to the repair output circuit. The repair image data is image data to be provided to a shift register unit connected to the broken data signal transmission line.

The repair output circuit is respectively electrically connected to the data processing circuit and at least one repair signal transmission line, and is configured to, according to the preprocessed repair image data, generate a data signal, which is to be sent to the data signal line to which the broken data signal transmission line is connected.

The repair signal connection line is respectively electrically connected to a corresponding repair signal transmission line and the data signal line to which the broken data signal transmission line is connected, and different repair signal connection lines are connected to different data signal lines.

The number of the repair signal transmission lines is greater than or equal to the number of the broken data signal transmission lines.

In an exemplary implementation mode, the repair output circuit is disposed on the chip on film, the repair signal transmission line is disposed on the display panel and the chip on film, and the repair signal connection line is disposed on the display panel.

In an exemplary implementation mode, the repair output circuit includes a repair shift register, a repair data latch circuit, a repair level conversion circuit, a repair digital-to-analog conversion circuit, and a repair output buffer circuit.

The repair shift register is electrically connected to the data processing circuit and is configured to sample and output the repair image data to generate a first repair data signal.

The repair data latch circuit is electrically connected to the repair shift register and is configured to latch the first repair data signal and output a second repair data signal.

The repair level conversion circuit is electrically connected to the repair data latch circuit and is configured to convert the second repair data signal to a third repair data signal, and a level of the third repair data signal is greater than a level of the second repair data signal.

The repair digital-to-analog conversion circuit is configured to convert the third repair data signal into a data signal, the third repair data signal is a digital signal and the data signal is an analog signal.

The repair output buffer circuit is respectively electrically connected to the repair digital-to-analog conversion circuit and the repair signal transmission line, and is configured to send the data signal to the repair signal transmission line.

In an exemplary implementation mode, the repair signal connection line is laser-welded to the data signal line to which the broken data signal transmission line is connected.

In an exemplary implementation mode, the repair module includes a plurality of repair control circuits, a selection circuit, a repair signal transmission line, a first repair signal connection line, and a second repair signal connection line. An extension direction of the first repair signal connection line and an extension direction of the second repair signal connection line intersect respectively with an extension direction of the repair signal transmission line, and the extension direction of the repair signal transmission line is the same as the extension directions of the data signal transmission lines.

The data processing circuit is configured to generate a control signal.

The repair control circuits are electrically connected to the data processing circuit and the selection circuit, respectively, and are configured to generate repair control signals according to the control signal.

The selection circuit is electrically connected to the signal output circuits, the repair control circuits, the data signal transmission lines, and the first repair signal connection line, respectively, and is configured to transmit data signals output by the signal output circuits to the data signal transmission lines or the first repair signal connection line under control of the repair control signals.

The repair signal transmission line is electrically connected to the first repair signal connection line and the second repair signal connection line, respectively, and the second repair signal connection line is electrically connected to the data signal line to which the broken data signal transmission line is connected.

In an exemplary implementation mode, the repair control circuits, the selection circuit, and the first repair signal connection line are disposed on the chip on film, the repair signal transmission line is disposed on the display panel and the chip on film, and the second repair signal connection line is disposed on the display panel.

In an exemplary implementation mode, the number of the repair control circuits is the same as the number of the signal output circuits. A repair control circuit includes a control shift register and a control level conversion circuit, the selection circuit includes a plurality of selection switches, and a selection switch of the plurality of selection switches includes a control terminal, a first terminal, a second terminal, and a third terminal.

The control shift register is electrically connected to the data processing circuit and the control level conversion circuit, respectively, and is configured to sample and output the control signal to generate an intermediate control signal.

The control level conversion circuit is electrically connected to the control shift register and the selection circuit, and is configured to convert the intermediate control signal to a repair control signal. A level of the repair control signal is greater than a level of the intermediate control signal.

The control terminal of the selection switch is electrically connected to a connected control level conversion circuit, the first terminal of the selection switch is electrically connected to a connected signal output circuit, the second terminal of the selection switch is electrically connected to a connected data signal transmission line, and a third terminal of the selection switch is electrically connected to the first repair signal connection line.

In an exemplary implementation mode, the second repair signal connection line is laser-welded to the data signal line to which the broken data signal transmission line is connected.

In an exemplary implementation mode, the repair module includes a plurality of repair signal connection lines, and extension directions of the repair signal connection lines intersect with extension directions of the data signal lines.

A repair signal connection line of the plurality of repair signal connection lines is electrically connected to the data signal line to which the broken data signal transmission line is connected and a data signal line to which a data signal transmission line adjacent to the broken data signal transmission line is connected, and repair signal connection lines connected to different data signal transmission lines are different.

The number of the repair signal connection lines is greater than or equal to the number of broken data signal transmission lines.

In an exemplary implementation mode, the repair module further includes a switch circuit including a plurality of switches, and the plurality of switches and the plurality of repair signal connection lines are in a one-to-one correspondence.

A switch of the plurality of switches is electrically connected to a corresponding repair signal connection line.

In an exemplary implementation mode, a repair signal trace is a metal trace.

The repair signal connection line is laser-welded to the data signal line to which the broken data signal transmission line is connected, and the repair signal connection line is laser-welded to the data signal line to which the data signal transmission line adjacent to the broken data signal transmission line is connected.

In an exemplary implementation mode, when the shift register includes a plurality of shift register units and the repair shift register includes a plurality of repair shift register units, the shift register units include a first shift register unit and a second shift register unit, polarities of the first shift register unit and the second shift register unit are opposite, the repair shift register units include a first repair shift register unit and a second repair shift register unit, polarities of the first repair shift register unit and the second repair shift register unit are opposite, and the polarity of the first shift register unit is the same as the polarity of the first repair shift register unit.

The data processing circuit sequentially sends a plurality of image data, which should be transmitted to shift register units to which broken data signal transmission lines are connected, to a plurality of repair shift register units, or sends image data, which should be transmitted to the first shift register unit to which the broken data signal transmission line is connected, to the first repair shift register unit and sends image data, which should be transmitted to the second shift register unit to which the broken data signal transmission line is connected, to the second repair shift register unit.

In an exemplary implementation mode, a printed circuit board is also included.

The printed circuit board is electrically connected to the chip on film.

In a second aspect, the present disclosure also provides a control method for a display apparatus, which is configured to control the display apparatus described above, and the method includes:
a source drive circuit provides a data signal to an unbroken data signal transmission line, and
a repair module provides a data signal to a data signal line to which a broken data signal transmission line is connected.

In an exemplary implementation mode, the source driver includes a data processing circuit and a plurality of shift register units, and the repair module includes a plurality of repair output circuits. The repair module transmits the data signal to the data signal line to which the broken data signal transmission line is connected, including:
the data processing circuit acquires a set of defect identifications stored in advance, the set of defect identifications includes an identification of a shift register unit electrically connected to the broken data signal transmission line, and the identification includes a serial number of the shift register unit or an address of the shift register unit, and
the data processing circuit determines whether an identification of a shift register unit by which image data is to be sent is located in the set of defect identifications stored in advance, when the identification of the shift register unit by which the image data is to be sent is not located in the set of defect identifications stored in advance, the data processing circuit sends preprocessed image data to the shift register unit, and when the identification of the shift register unit by which the image data is to be sent is located in the set of defect identifications stored in advance, the data processing circuit sends preprocessed repair image data to a repair output circuit of the plurality of repair output circuits, the repair image data is image data to be provided to a shift register unit connected to the broken data signal transmission line, and
the repair output circuit generates, according to the preprocessed repair image data, a data signal which is to be provided to the data signal line to which the broken data signal transmission line is connected, and provides the data signal to the data signal line to which the broken data signal transmission line is connected.

Other aspects may be comprehended after the drawings and the detailed descriptions are read and understood.

### BRIEF DESCRIPTION OF DRAWINGS

Accompanying drawings are intended to provide an understanding of technical solutions of the present disclosure and constitute a part of the specification, and are used to explain technical solutions of the present application together with embodiments of the present application, but do not constitute limitations on the technical solutions of the present application.

FIG. 1 is a schematic diagram of a structure of a display apparatus.

FIG. 2 is a first partial schematic diagram of a display apparatus according to an embodiment of the present disclosure.

FIG. 3 is a second partial schematic diagram of a display apparatus according to an embodiment of the present disclosure.

FIG. 4 is a third partial schematic diagram of a display apparatus according to an embodiment of the present disclosure.

FIG. 5 is a fourth partial schematic diagram of a display apparatus according to an embodiment of the present disclosure.

FIG. 6 is a fifth partial schematic diagram of a display apparatus according to an embodiment of the present disclosure.

FIG. 7 is a sixth partial schematic diagram of a display apparatus according to an embodiment of the present disclosure.

### DETAILED DESCRIPTION

To make objectives, technical solutions, and advantages of the present disclosure clearer, the embodiments of the present disclosure will be described in detail below with reference to the accompanying drawings. It is to be noted that implementation modes may be implemented in multiple different forms. Those of ordinary skills in the art may easily understand such a fact that modes and contents may be transformed into various forms without departing from the purpose and scope of the present disclosure. Therefore, the present disclosure should not be explained as being limited to the contents recorded in the following implementation modes only. The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings of the embodiments of the present disclosure only involve structures involved in the embodiments of the present disclosure, and for other structures, reference may be made to conventional designs.

In the accompanying drawings, a size of each constituent element, a thickness of a layer, or a region may be exaggerated sometimes for clarity. Therefore, a mode of the present disclosure is not necessarily limited to the size, and a shape and a size of each component in the drawings do not reflect an actual scale. In addition, the accompanying drawings schematically illustrate ideal examples, and a mode of the present disclosure is not limited to shapes, numerical values, or the like shown in the drawings.

Ordinal numerals “first”, “second”, “third” and the like in the specification are set not to form limits in numbers but only to avoid confusion between constituent elements.

In the specification, for convenience, expressions “central”, “above”, “below”, “front”, “back”, “vertical”, “horizontal”, “top”, “bottom”, “inside”, “outside” and the like for indicating directional or positional relationships are used to illustrate positional relationships between the constituent elements with reference to the accompanying drawings, not to indicate or imply that involved devices or elements are required to have specific orientations or are structured and operated in the specific orientations but only to easily describe the present specification and simplify the description, and thus should not be understood as limitations on the present disclosure. The positional relationships between the constituent elements may be changed as appropriate based on a direction according to which each constituent element is described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, a connection may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a first pole may be a drain electrode, and a second pole may be a source electrode. Or, the first pole may be a source electrode, and the second pole may be a drain electrode. In a case that transistors with opposite polarities are used, or in a case that a direction of a current changes during operation of a circuit, or the like, functions of the “source electrode” and the “drain electrode” are sometimes interchangeable. Therefore, the “source electrode” and the “drain electrode” are interchangeable in the specification.

In the specification, an “electrical connection” includes a case that constituent elements are connected together through an element with a certain electrical action. The “element with a certain electrical action” is not particularly limited as long as electrical signals between the connected constituent elements may be sent and received. Examples of the “element with a certain electrical action” not only include an electrode and a wiring, but also include a switching element such as a transistor, a resistor, an inductor, a capacitor, other elements with various functions, etc.

In the specification, “parallel” refers to a state in which an angle formed by two straight lines is above −10°and below 10°, and thus may include a state in which the angle is above −5° and below 5°. In addition, “perpendicular” refers to a state in which an angle formed by two straight lines is above 80°and below 100°, and thus may include a state in which the angle is above 85°and below 95°.

In the specification, a “film” and a “layer” are interchangeable. For example, a “conductive layer” may be replaced with a “conductive film” sometimes. Similarly, an “insulation film” may be replaced with an “insulating layer” sometimes.

In the specification, “disposed in a same layer” adopted refers to a structure formed by patterning two (or more than two) structures through a same patterning process, and their materials may be the same or different. For example, materials of precursors for forming multiple structures disposed in a same layer are the same, and materials finally formed may be the same or different.

A triangle, rectangle, trapezoid, pentagon, or hexagon, or the like in the specification is not strictly defined, and it may be an approximate triangle, rectangle, trapezoid, pentagon, or hexagon, or the like. There may be some small deformations caused by tolerance, and there may be a chamfer, an arc edge, deformation, etc.

In the present disclosure, “about” means that a boundary is not defined so strictly and numerical values within process and measurement error ranges are allowed.

A display apparatus is usually connected to a PCB (printed circuit board) and a display screen through a COF (chip on film), on which a driver is disposed. Due to a complicated structure of the driver disposed on the chip on film, the manufacturing yield of the COF is low, and the possibility of defects occurring during assembly with the driver is very large. When there are manufacturing defects in the COF or the assembly with the driver is not good, the chip on film cannot be used but can only be discarded, resulting in a waste of resources.

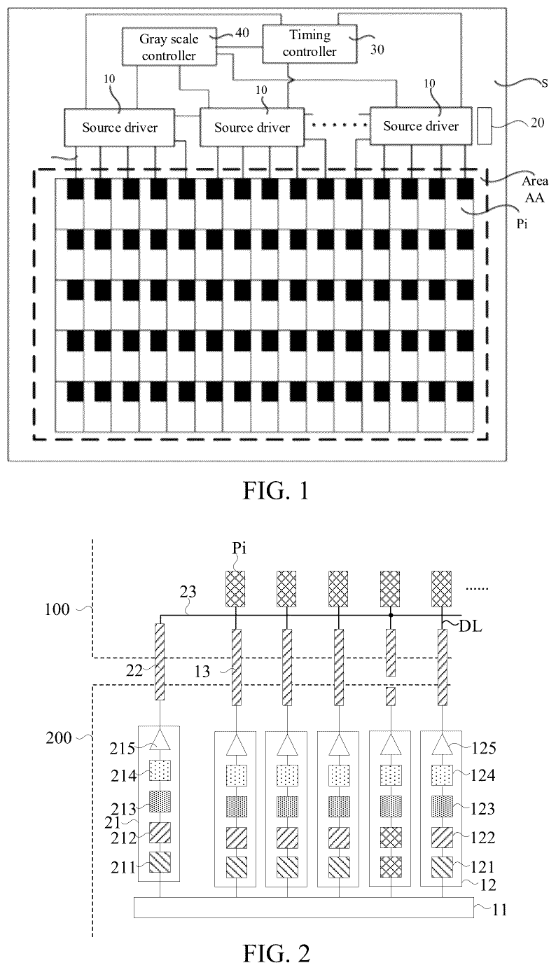

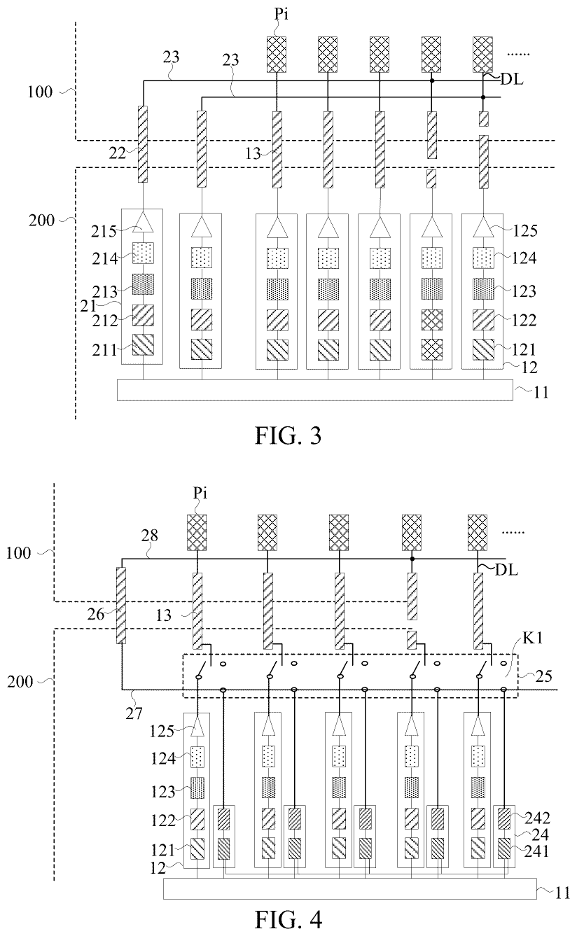

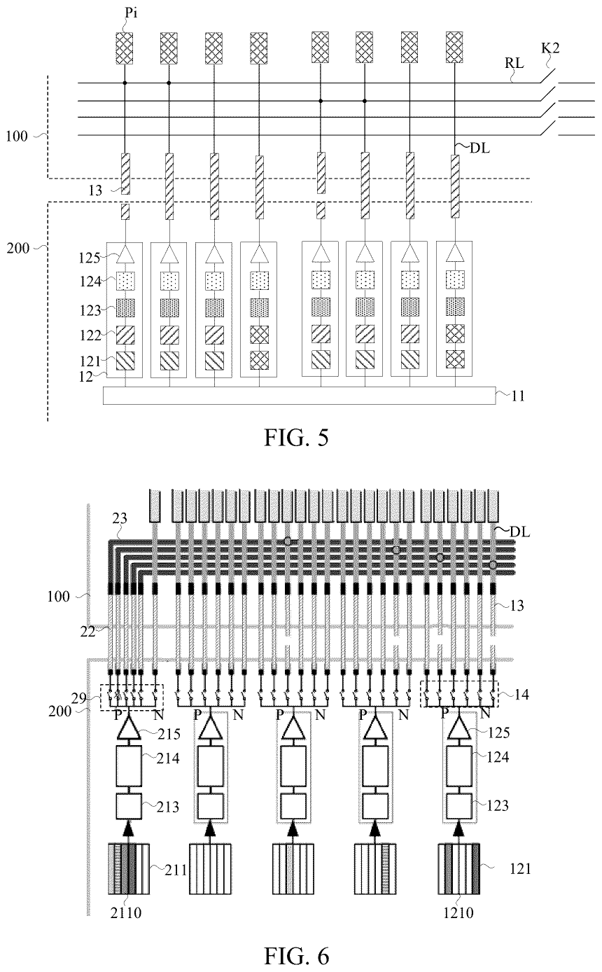

FIG. 1 is a schematic diagram of a structure of a display apparatus, FIG. 2 is a first partial schematic diagram of a display apparatus according to an embodiment of the present disclosure, FIG. 3 is a second partial schematic diagram of a display apparatus according to an embodiment of the present disclosure, FIG. 4 is a third partial schematic diagram of a display apparatus according to an embodiment of the present disclosure, and FIG. 5 is a fourth partial schematic diagram of a display apparatus according to an embodiment of the present disclosure. As shown in FIGS. 1 to 5, a display apparatus according to an embodiment of the present disclosure includes a display panel 100 and a source driver 10 located on at least one side of the display panel 100. The display panel 100 is provided with sub-pixels Pi arranged in an array and a plurality of data signal lines DL, and the sub-pixels Pi are electrically connected to the data signal lines DL. The display apparatus further includes a repair module 20 and a plurality of data signal transmission lines 13. Some of the data signal transmission lines 13 are broken, and extension directions of the data signal transmission lines 13 are the same as extension directions of the data signal lines DL. The data signal transmission lines 13 are electrically connected to the source driver 10 and the data signal lines DL, respectively. FIGS. 2 and 4 are illustrated by taking one data signal transmission line 13 being broken as an example, and FIGS. 3 and 5 are illustrated by taking two data signal transmission lines 13 being broken as an example.

In an exemplary implementation mode, the source driver 10 is electrically connected to an unbroken data signal transmission line, and is configured to provide a data signal to the unbroken data signal transmission line. The repair module 20 is electrically connected to a data signal line to which a broken data signal transmission line is connected, and is configured to provide a data signal to the data signal line to which the broken data signal transmission line is connected.

In an exemplary implementation mode, as shown in FIG. 1, the display apparatus includes a display area AA and a peripheral area S. The display panel is at least partially located in the display area, and the source driver 10 is located in the peripheral area S.

In an exemplary implementation mode, there are multiple source drivers 10, and the multiple source drivers 10 are sequentially cascaded.

In an exemplary implementation mode, the repair module may be located on a side of the first source driver away from the second source driver, or may be located on a side of the last source driver away from the second-to-last source driver, or may be located between source drivers, which is not limited in the present disclosure.

In an exemplary implementation mode, the display panel may be a liquid crystal display panel, an OLED display panel, or a QLED display panel. When the display panel is a liquid crystal display panel, a sub-pixel includes a common electrode, a pixel electrode, and a liquid crystal layer. When the display panel is an OLED display panel or a QLED display panel, a sub-pixel includes a pixel drive circuit and a light emitting device.

In an exemplary implementation mode, the display apparatus may be a Liquid Crystal Display (LCD for short) apparatus or an Organic Light Emitting Diode (OLED for short) display apparatus. The display apparatus may be any product or component with a display function, such as a liquid crystal panel, electronic paper, an OLED panel, an Active-Matrix Organic Light Emitting Diode (AMOLED for short) panel, a mobile phone, a tablet computer, a television, a display, a notebook computer, a digital photo frame, and a navigator.

In an exemplary implementation mode, the light emitting device may be an Organic Light Emitting Diode (OLED), including a first electrode (anode), an organic emitting layer, and a second electrode (cathode), which are stacked.

In an exemplary implementation mode, a sub-pixel includes a first sub-pixel that emits light of a first color, a second sub-pixel that emits light of a second color, and a third sub-pixel that emits light of a third color. Multiple sub-pixels form one pixel unit.

In an exemplary implementation mode, a sub-pixel may be in a shape of a rectangle, a rhombus, a pentagon, or a hexagon. Three sub-pixels may be arranged side by side horizontally, side by side vertically, or in a manner of a Chinese character “ [symbol] ” , the present disclosure is not limited thereto.

In an exemplary implementation mode, one pixel unit may include three sub-pixels, and the three sub-pixels may be arranged side by side horizontally, side by side vertically, or in a manner of a Chinese character “ [symbol] ” , and the present disclosure is not limited thereto.

In an exemplary implementation mode, one pixel unit may include four sub-pixels, and the four sub-pixels may be one first sub-pixel, one second sub-pixel, and two third sub-pixels. The four sub-pixels may be arranged in a manner of standing side by side horizontally, in a manner of standing side by side vertically, or in a manner of a square, which is not limited in the present disclosure.

In an exemplary implementation mode, the organic emitting layer may include a Hole Injection Layer (HIL), a Hole Transport Layer (HTL), an Electron Block Layer (EBL), an Emitting Layer (EML), a Hole Block Layer (HBL), an Electron Transport Layer (ETL), and an Electron Injection Layer (EIL) that are stacked. In an exemplary implementation mode, hole injection layers of all sub-pixels may be connected together to be a common layer, electron injection layers of all the sub-pixels may be connected together to be a common layer, hole transport layers of all the sub-pixels may be connected together to be a common layer, electron transport layers of all the sub-pixels may be connected together to be a common layer, hole block layers of all the sub-pixels may be connected together to be a common layer, emitting layers of adjacent sub-pixels may be overlapped slightly or may be isolated, and electron block layers of adjacent sub-pixels may be overlapped slightly or may be isolated.

In an exemplary implementation mode, as shown in FIG. 1, the peripheral area S is further provided with a timing controller 30, and the timing controller 30 is electrically connected to the source driver 10. Further, the source driver 10 is electrically connected to the sub-pixels through the data signal lines DL.

In some embodiments of the present invention, as shown in FIG. 1, the peripheral area S is further provided with a gray scale controller 40, and the gray scale controller 40 is electrically connected to the source driver 10 and the timing controller 30. The gray scale controller 40 is user to output a gamma signal to the source driver 10 according to gray scale data of sub-pixels in a display image from the timing controller 30.

A display apparatus according to an embodiment of the present disclosure includes a display panel and a source driver located on at least one side of the display panel. The display panel is provided with sub-pixels arranged in an array and a plurality of data signal lines, and the sub-pixels are electrically connected to the data signal lines. The display apparatus further includes a repair module and a plurality of data signal transmission lines. Some of the data signal transmission lines are broken, and extension directions of the data signal transmission lines are the same as extension directions of the data signal lines. The data signal transmission lines are electrically connected to the source driver and the data signal lines respectively. The source driver is electrically connected to an unbroken data signal transmission line, and is configured to provide a data signal to the unbroken data signal transmission line. The repair module is electrically connected to a data signal line to which a broken data signal transmission line is connected, and is configured to provide a data signal to the data signal line to which the broken data signal transmission line is connected. In the present disclosure, by providing the repair module, a signal can be provided to a data signal line to which a broken data signal transmission line is connected when there are manufacturing defects in the COF or assembly with the driver is not good, thereby ensuring normal display of the display apparatus and avoiding waste.

In an exemplary implementation mode, when the display apparatus includes a chip on film 200, the source driver is disposed on the chip on film.

In an exemplary implementation mode, the repair module is disposed on at least one of the display panel and the chip on film, and the data signal transmission lines 13 are disposed on the display panel 100 and the chip on film 200.

In an exemplary implementation mode, as shown in FIGS. 2 to 5, the source driver may include a data processing circuit 11 and a plurality of signal output circuits 12. A signal output circuit 12 may include a shift register 121, a data latch circuit 122, a level conversion circuit 123, a digital-to-analog conversion circuit 124, and an output buffer circuit 125.

In an exemplary implementation mode, the source driver may further include a plurality of interface circuits, which is electrically connected to the data processing circuit and is configured to convert a signal received from the timing controller 20 into image data and output the image data to the data processing circuit.

In an exemplary implementation mode, the plurality of interface circuits 101 may have a same structure. The image data received by the plurality of interface circuits may be adjusted according to positions of the sub-pixels in the display panel, which is not limited in the present disclosure. Further, interface types of the interface circuits are also not limited in the present disclosure, and may be set by those skilled in the art according to an actual situation. Exemplarily, the interface circuits may include Mini Low Voltage Differential Signaling (Mini-LVDS for short) interfaces, and Point-to-Point (P2P for short) interfaces.

In an exemplary implementation mode, the data processing circuit 11 may be configured to preprocess the received image data. Exemplarily, the preprocessing includes performing data reverse processing, performing serial-to-parallel conversion processing, implementing a data exchange (SWAP) function, and etc., on the image data. The data processing circuit processes digital signals, and compared with disposing a data processor before an input terminal of the output buffer circuit to process analog signals, speed and accuracy of signal processing can be improved. Further, compared with disposing the data processing circuit in a high voltage region, disposing the data processing circuit in a low voltage region makes it possible to reduce a size of the source driver 10.

In an exemplary implementation mode, the data processing circuit 11 is further configured to provide a shift register signal to the shift register, the shift register signal may include an initial signal or a reset signal.

In an exemplary implementation mode, the shift register 121 is electrically connected to the data processing circuit 11, and is configured to sample and output the preprocessed image data to generate a first data signal.

In an exemplary implementation mode, both the preprocessed image data and the first data signal are digital signals.

In an exemplary implementation mode, the shift register includes at least one shift register unit. When the shift register includes a plurality of shift register units, a plurality of shift register units located in a same shift register are cascaded with each other.

In an exemplary implementation mode, the data latch circuit 122 is electrically connected to the shift register 121, and is configured to latch the first data signal and output a second data signal.

In an exemplary implementation mode, the data latch circuits correspond to the shift registers in a one-to-one correspondence. That is, the number of the data latch circuits is the same as the number of the shift registers. An output of the data latch circuit is a parallel output. It can be understood that since the shift register units in the shift register sequentially sample and output digitized image data, that is, an output of the shift register is a serial output, the data latch circuit sequentially latches a first data signal output by a corresponding shift register.

In an exemplary implementation mode, each data latch circuit includes a plurality of data latch units, and the number of data latch units in a data latch circuit is positively correlated with a shift register corresponding to that data latch circuit. For example, the number of data latch units in a data latch circuit may be the number of shift register units in a shift register corresponding to that data latch circuit multiplied by a size of data capacity sampled by that shift register. For example, if data capacity sampled by a shift register is 80 bits, and the shift register includes 24 shift register units, then there are at least 1920 data latch units in the data latch circuit corresponding to the shift register.

In an exemplary implementation mode, the level conversion circuit 123 is electrically connected to the data latch circuit 122, and is configured to convert the second data signal into a third data signal. A level of the third data signal is greater than a level of the second data signal. In an exemplary implementation mode, an output of the level conversion circuit is a parallel output. The level conversion circuit converts the second data signal of a low level into the third data signal of a high level to be suitable for a voltage of a drive transistor in a pixel drive circuit.

In an exemplary implementation mode, the digital-to-analog conversion circuit 124 is configured to convert the third data signal into a data signal. The third data signal is a digital signal, and the data signal is an analog signal.

In an exemplary implementation mode, the digital-to-analog conversion circuit combines the gamma signal from the gray scale controller to convert the received third data signal into a data signal, and the data signal is an analog gray scale signal.

In an exemplary implementation mode, the output buffer circuit 125 is electrically connected to the digital-to-analog conversion circuit 124 and the data signal transmission line 13 respectively, and is configured to transmit the data signal to the unbroken data signal transmission line.

In an exemplary implementation mode, the number of output buffer circuits is the same as the number of digital-to-analog conversion circuits. An output terminal of one output buffer circuit is electrically connected to one data signal line DL, and the output buffer circuit can improve driving capability of the source driver 10, that is, the ability for driving load of the source driver 10.

In an exemplary implementation mode, the plurality of data signal transmission lines 13 and the plurality of data signal lines DL have a one-to-one correspondence relationship.

In an exemplary implementation mode, the number of shift register units in a signal output circuit is the same as the number of data signal transmission lines to which the signal output circuit is connected, and there is a one-to-one correspondence between the shift register units in the signal output circuit and the data signal transmission lines to which the signal output circuit is connected.

In an exemplary implementation mode, the display apparatus may further include a memory. The memory is configured to store a set of defect identifications. The set of defect identifications includes an identification of a shift register unit electrically connected to a broken data signal transmission line, and the identification includes a serial number of the shift register unit or an address of the shift register unit.

In an exemplary implementation mode, the memory may be a disposable memory, or may be a memory within the display apparatus, which is not limited in the present disclosure.

In an exemplary implementation mode, a preparation process of the display apparatus includes providing a display panel; providing a chip on film; assembling the chip on film and the display panel; testing the assembled chip on film and display panel; disposing a repair module in the display apparatus when the test fails; carrying out a source output display test after the display apparatus disposed with the repair module is prepared; determining whether the number of broken data signal transmission lines is greater than the number of repair output circuits in the repair module if the display is abnormal; if the number of the broken data signal transmission lines is greater than the number of the repair output circuits in the repair module, then ending the process, the display apparatus being not capable of displaying normally, and if the number of the broken data signal transmission lines is less than the number of the repair output circuits in the repair module, then storing identifications of shift register units electrically connected to the broken data signal transmission lines in the memory.

In an exemplary implementation mode, as shown in conjunction with FIGS. 1, 2, and 3, the repair module may include at least one repair output circuit 21, at least one repair signal transmission line 22, and at least one repair signal connection line 23. FIG. 2 is illustrated by taking one repair output circuit, one repair signal transmission line, and one repair signal connection line as an example, and FIG. 3 is illustrated by taking two repair output circuits, two repair signal transmission lines, and two repair signal connection lines as an example.

In an exemplary implementation mode, as shown in FIGS. 2 and 3, an extension direction of the repair signal transmission line 22 intersects with an extension direction of the repair signal connection line 23, there is a one-to-one correspondence between the repair signal transmission lines 22 and the repair signal connection lines 23, and the extension direction of the repair signal transmission line 22 is the same as an extension direction of the data signal transmission line 13.

In an exemplary implementation mode, as shown in FIGS. 2 and 3, the data processing circuit 11 is configured to acquire a set of defective identifications stored in advance, and determine whether an identification of a shift register unit by which image data is to be sent is located in the set of defective identifications stored in advance. When the identification of the shift register unit by which the image data is to be sent is not located in the set of defect identifications stored in advance, the data processing circuit sends preprocessed image data to the shift register unit. When the identification of the shift register unit by which the image data is to be sent is located in the set of defect identifications stored in advance, the data processing circuit sends preprocessed repair image data to a repair output circuit, the repair image data is image data that should be provided to a shift register unit connected to a broken data signal transmission line.

In an exemplary implementation mode, as shown in FIGS. 2 and 3, the repair output circuit 21 is electrically connected to the data processing circuit 11 and at least one repair signal transmission line 22 respectively, and is configured to generate a data signal, which is to be sent to a data signal line to which the broken data signal transmission line is connected, according to the preprocessed repair image data.

In an exemplary implementation mode, as shown in FIGS. 2 and 3, a repair signal connection line 23 is electrically connected to a corresponding repair signal transmission line 22 and a data signal line to which a broken data signal transmission line is connected, respectively.

In an exemplary implementation mode, as shown in FIGS. 2 and 3, different repair signal connection lines are connected to different data signal lines. By connecting different repair signal connection lines to different data signal lines, crosstalk between signals can be avoided. In an exemplary implementation mode, the number of the repair signal transmission lines 22 is greater than or equal to the number of broken data signal transmission lines.

In an exemplary implementation mode, as shown in FIGS. 2 and 3, the repair output circuit 21 is disposed on the chip on film 200, the repair signal transmission line 22l is disposed on the display panel 100 and the chip on film 200, and the repair signal connection line 23 is disposed on the display panel 100.

In an exemplary implementation mode, as shown in FIGS. 2 and 3, the repair output circuit 21 includes a repair shift register 211, a repair data latch circuit 212, a repair level conversion circuit 213, a repair digital-to-analog conversion circuit 214, and a repair output buffer circuit 215.

The repair shift register 211 is electrically connected to the data processing circuit, and is configured to sample and output the preprocessed repair image data to generate a first repair data signal.

The repair data latch circuit 212 is electrically connected to the repair shift register 211, and is configured to latch the first repair data signal and output a second repair data signal.

The repair level conversion circuit 213 is electrically connected to the repair data latch circuit 212, and is configured to convert the second repair data signal into a third repair data signal. A level of the third repair data signal is greater than a level of the second repair data signal.

The repair digital-to-analog conversion circuit 214 is configured to convert the third repair data signal into a data signal. The third repair data signal is a digital signal and the data signal is an analog signal.

The repair output buffer circuit 215 is electrically connected to the repair digital-to-analog conversion circuit 214 and a repair signal transmission line 22, respectively, and is configured to send a data signal to the repair signal transmission line 22.

In an exemplary implementation mode, the repair signal connection line 23 is laser-welded to a data signal line which a broken data signal transmission line is connected.

In an exemplary implementation mode, as shown in conjunction with FIGS. 1 and 4, the repair module may include a plurality of repair control circuits 24, a selection circuit 25, a repair signal transmission line 26, a first repair signal connection line 27, and a second repair signal connection line 28.

In an exemplary implementation mode, as shown in FIG. 4, an extension direction of the first repair signal connection line 27 and an extension direction of the second repair signal connection line 28 intersect respectively with an extension direction of the repair signal transmission line 26, and the extension direction of the repair signal transmission line 26 is the same as extension directions of the data signal transmission lines 13.

In an exemplary implementation mode, the data processing circuit 11 is configured to generate a control signal.

In an exemplary implementation mode, the repair control circuits 24 are electrically connected to the data processing circuit 11 and the selection circuit 25, respectively, and are configured to generate repair control signals according to the control signal.

In an exemplary implementation mode, the selection circuit 25 is electrically connected to the signal output circuits, the repair control circuits 24, the data signal transmission lines, and the first repair signal connection line, respectively, and is configured to transmit data signals output by the signal output circuits to the data signal transmission lines or the first repair signal connection line under control of the repair control signals.

In an exemplary implementation mode, the repair signal transmission line 26 is electrically connected to the first repair signal connection line 27 and the second repair signal connection line 28, respectively, and the second repair signal connection line 28 is electrically connected to a data signal line to which a broken data signal transmission line is connected.

In an exemplary implementation mode, as shown in FIG. 4, the repair control circuits 24, the selection circuit 25, and the first repair signal connection line 27 are disposed on the chip on film 200, the repair signal transmission line 26 is disposed on the display panel 100 and the chip on film 200, and the second repair signal connection line 28 is disposed on the display panel 100.

In an exemplary implementation mode, as shown in FIG. 4, the number of the repair control circuits 24 is the same as the number of the signal output circuits 12, and a repair control circuit 24 includes a control shift register 241 and a control level conversion circuit 242. The selection circuit 25 includes a plurality of selection switches K1, and a selection switch K1 includes a control terminal, a first terminal, a second terminal, and a third terminal.

In an exemplary implementation mode, as shown in FIG. 4, the control shift register 241 is electrically connected to the data processing circuit 11 and the control level conversion circuit 242, respectively, and is configured to sample and output the control signal to generate an intermediate control signal.

In an exemplary implementation mode, as shown in FIG. 4, the control level conversion circuit 242 is electrically connected to the control shift register 241 and the selection circuit 25, and is configured to convert the intermediate control signal into the repair control signal. The level of the repair control signal is greater than the level of the intermediate control signal.

In an exemplary implementation mode, as shown in FIG. 4, a control terminal of a selection switch is electrically connected to a connected control level conversion circuit 242, a first terminal of the selection switch is electrically connected to a connected signal output circuit 12, a second terminal of the selection switch is electrically connected to a connected data signal transmission line 13, and a third terminal of the selection switch is electrically connected to the first repair signal connection line 27.

In an exemplary implementation mode, as shown in FIG. 4, the second repair signal connection line 28 is laser-welded to a data signal line to which a broken data signal transmission line is connected.

In an exemplary implementation mode, as shown in conjunction with FIGS. 1 and 5, the repair module 20 includes a plurality of repair signal connection lines RL, and extension directions of the repair signal connection lines RL intersect with extension directions of the data signal lines DL.

In an exemplary implementation mode, as shown in FIG. 5, a repair signal connection line is electrically connected to a data signal line to which a broken data signal transmission line is connected, and a data signal line to which a data signal transmission line adjacent to the broken data signal transmission line is connected. In the present disclosure, by disposing the repair signal connection lines, it is possible to provide to a data signal line, to which a broken data signal transmission line is connected, a data signal that should be sent to an adjacent data signal line.

In an exemplary implementation mode, the repair signal connection lines may be located on the display panel, or may be located on the chip on film.

In an exemplary implementation mode, as shown in FIG. 5, repair signal connection lines RL connected to different data signal transmission lines 13 are different.

In an exemplary implementation mode, as shown in FIG. 5, the number of the repair signal connection lines RL is greater than or equal to the number of broken data signal transmission lines. FIG. 5 is illustrated by taking four repair signal connection lines RL as an example.

In an exemplary implementation mode, as shown in FIG. 5, the repair signal connection lines RL are disposed on the display panel 100 or the chip on film 200.

In an exemplary implementation mode, as shown in FIG. 5, the repair module further includes a switch circuit including a plurality of switches K2, and the plurality of switches K2 correspond to the plurality of repair signal connection lines RL in a one-to-one correspondence. A switch is electrically connected to a corresponding repair signal connection line. In the present disclosure, the providing of the switches can increase driving currents when the repair signal connection lines transmit signals, and ensure driving capability of signals provided to the data signal lines.

In an exemplary implementation mode, when some source channels in the display panel are not used, the repair signal connection lines may be connected to the unused source channels, and correct data signals will be transmitted to the source channels, thereby ensuring normal display of the display apparatus, herein a source channel refers to a channel for transmitting a data signal and may at least include a data signal transmission line and a data signal line.

In an exemplary implementation mode, the repair signal trace may be a metal trace.

In an exemplary implementation mode, a repair signal connection line is laser-welded to a data signal line to which a broken data signal transmission line is connected, and the repair signal connection line is laser-welded to a data signal line to which a data signal transmission line adjacent to the broken data signal transmission line is connected.

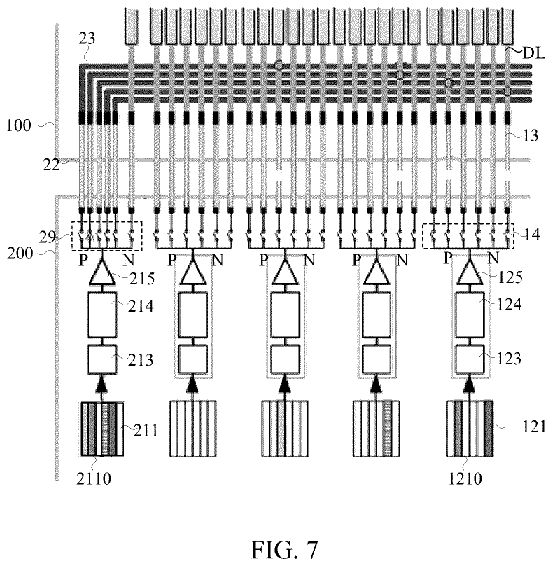

In an exemplary implementation mode, FIG. 6 is a fifth partial schematic diagram of a display apparatus according to an embodiment of the present disclosure, and FIG. 7 is a sixth partial schematic diagram of a display apparatus according to an embodiment of the present disclosure. Repair modules as shown in FIGS. 6 and 7 are the same as those shown in FIGS. 2 and 3. As shown in FIGS. 6 and 7, when the shift register 121 includes a plurality of shift register units 1210 and the repair shift register 211 includes a plurality of repair shift register units 2110, the shift register units include a first shift register unit and a second shift register unit, polarities of the first shift register unit and the second shift register unit are opposite, the repair shift register units include a first repair shift register unit and a second repair shift register unit, polarities of the first repair shift register unit and the second repair shift register unit are opposite, and the polarity of the first shift register unit is the same as the polarity of the first repair shift register unit. The polarity of the first shift register unit and the polarity of the first repair shift register unit in FIGS. 6 and 7 are positive polarity P, the polarity of the second shift register unit and the polarity of the second repair shift register unit are positive polarity N, the polarity of a shift register unit on the left side of the shift register in FIGS. 6 and 7 is positive polarity, and the polarity of a shift register unit on the right side of the shift register is negative polarity. An advantage of FIG. 6 is that there is no need to determine polarities of the shift register units and the repair shift register units, but its disadvantage is that the polarity of a signal cannot be accurately displayed, and sometimes the polarity of the signal may be opposite to the polarity of a repair shift register unit where the signal is located. An advantage of FIG. 7 is that the polarity of a signal can be accurately displayed, but its disadvantage is that it is needed to determine polarities of the shift register units and the repair shift register units.

In an exemplary implementation mode, when the shift register 121 includes a plurality of shift register units 1210 and the repair shift register 211 includes a plurality of repair shift register units 2110, the signal output circuit may further include a gating circuit 14. The gating circuit 14 includes a plurality of switches, and the plurality of switches is in a one-to-one correspondence relationship with the plurality of shift register units in the shift register and is in a one-to-one correspondence relationship with data signal output lines connected to the signal output circuit. The repair module may further include a repair gating circuit 29. The repair gating circuit 29 includes a plurality of switches, and some switches of the plurality of switches are in a one-to-one correspondence relationship with the plurality of repair shift register units, and are in a one-to-one correspondence relationship with the plurality of repair signal transmission lines.

In an exemplary implementation mode, one of the switches in the repair gating circuit is directly connected to a first data signal line along a repair signal transmission line.

In an exemplary implementation mode, the data processing circuit sequentially sends a plurality of image data, which should be transmitted to shift register units to which broken data signal transmission lines are connected, to a plurality of repair shift register units, or sends image data, which should be transmitted to the first shift register unit to which a broken data signal transmission line is connected, to the first repair shift register unit and sends image data, which should be transmitted to the second shift register unit to which a broken data signal transmission line is connected, to the second repair shift register unit. FIG. 6 is illustrated by taking sequentially sending a plurality of image data, which should be transmitted to shift register units to which broken data signal transmission line are connected, to a plurality of repair shift register units as an example. FIG. 7 is illustrated by taking sending image data, which should be transmitted to a first shift register unit to which a broken data signal transmission line is connected, to a first repair shift register unit and sending image data, which should be transmitted to a second shift register unit to which a broken data signal transmission line is connected, to a second repair shift register unit as an example.

In an exemplary implementation mode, the display apparatus may further include a printed circuit board. The printed circuit board is electrically connected to the chip on film.

An embodiment of the present disclosure also provides a control method for a display apparatus, which is configured to control the display apparatus. The display apparatus is a display apparatus provided by any one of the previous embodiments, and has similar implementation principles and implementation effects, which will not be repeated here.

The control method for the display apparatus may include the following acts: act 100 and act 200.

In act 100, a source drive circuit provides a data signal to an unbroken data signal transmission line.

In act 200, a repair module provides a data signal to a data signal line to which a broken data signal transmission line is connected.

In an exemplary implementation mode, the source driver includes a data processing circuit and a plurality of shift register units, and the repair module includes a plurality of repair output circuits. That the repair module transmits the data signal to the data signal line to which the broken data signal transmission line is connected, includes following contents.

The data processing circuit acquires a set of defect identifications stored in advance. The set of defect identifications includes an identification of a shift register unit electrically connected to a broken data signal transmission line, and the identification includes a serial number of the shift register unit or an address of the shift register unit.

The data processing circuit determines whether an identification of a shift register unit by which image data is to be sent is located in the set of defect identifications stored in advance. When the identification of the shift register unit by which the image data is to be sent is not located in the set of defect identifications stored in advance, the data processing circuit sends preprocessed image data to the shift register unit. When the identification of the shift register unit by which the image data is to be sent is located in the set of defect identifications stored in advance, the data processing circuit sends preprocessed repair image data to a repair output circuit, the repair image data is image data that is to be provided to a shift register unit connected to a broken data signal transmission line.

The repair output circuit generates a data signal, which is to be provided to the data signal line to which the broken data signal transmission line is connected, according to the preprocessed repair image data, and provides the data signal to the data signal line to which the broken data signal transmission line is connected.

The accompanying drawings of the present disclosure only involve structures involved in the embodiments of the present disclosure, and other structures may be referred to usual designs.

For the sake of clarity, a thickness and size of a layer or a micro structure are enlarged in the accompanying drawings used for describing the embodiments of the present disclosure. It may be understood that when an element such as a layer, film, region, or substrate is described as being “over” or “under” another element, the element may be “directly” located “over” or “under” the another element, or there may be an intermediate element.

Although implementations of the present disclosure are disclosed above, contents described are only implementations used for ease of understanding of the present disclosure, but not intended to limit the present disclosure. Any of those skilled in the art of the present disclosure can make any modifications and variations in the implementation and details without departing from the spirit and scope of the present disclosure. However, the protection scope of the present disclosure should be subject to the scope defined by the appended claims. Please replace the Claims with the following amended Claims.

1. A display apparatus, comprising: a display panel and a source driver located on at least one side of the display panel, wherein the display panel is provided with sub-pixels arranged in an array and a plurality of data signal lines, and the sub-pixels are electrically connected to the data signal lines, and the display apparatus further comprises a repair module and a plurality of data signal transmission lines, some of the data signal transmission lines are broken, and extension directions of the data signal transmission lines are the same as extension directions of the data signal lines, the data signal transmission lines are electrically connected to the source driver and the data signal lines, respectively, the source driver is electrically connected to an unbroken data signal transmission line, and is configured to provide a data signal to the unbroken data signal transmission line, and the repair module is electrically connected to a data signal line connected to a broken data signal transmission line, and is configured to provide a data signal to the data signal line connected to the broken data signal transmission line.

2. The display apparatus according to claim 1, wherein when the display apparatus comprises a chip on film, the source driver is disposed on the chip on film, and the repair module is disposed on at least one of the display panel and the chip on film, and the data signal transmission lines are disposed on the display panel and the chip on film.

3. The display apparatus according to claim 2, wherein the source driver comprises a data processing circuit and a plurality of signal output circuits, and a signal output circuit of the plurality of signal output circuits comprises a shift register, a data latch circuit, a level conversion circuit, a digital-to-analog conversion circuit, and an output buffer circuit, the data processing circuit is configured to preprocess received image data, the shift register is electrically connected to the data processing circuit and is configured to sample and output preprocessed image data to generate a first data signal, the data latch circuit is electrically connected to the shift register and is configured to latch the first data signal and output a second data signal, the level conversion circuit is electrically connected to the data latch circuit and is configured to convert the second data signal to a third data signal, and a level of the third data signal is greater than a level of the second data signal, the digital-to-analog conversion circuit is configured to convert the third data signal into a data signal, the third data signal is a digital signal and the data signal is an analog signal, the output buffer circuit is electrically connected to the digital-to-analog conversion circuit and a data signal transmission line of the data signal transmission lines, and is configured to send the data signal to the unbroken data signal transmission line, the shift register comprises at least one shift register unit, and when the shift register comprises a plurality of shift register units, the plurality of shift register units located in a same shift register are cascaded with each other, and the plurality of data signal transmission lines and the plurality of data signal lines are in a one-to-one correspondence relationship, and a number of shift register units in the signal output circuit is the same as a number of data signal transmission lines connected to the signal output circuit, and there is a one-to-one correspondence relationship between the shift register units in the signal output circuit and the data signal transmission lines connected to the signal output circuit.

4. The display apparatus according to claim 3, wherein the display apparatus further comprises a memory, and wherein the memory is configured to store a set of defect identifications, the set of defect identifications comprises an identification of a shift register unit electrically connected to the broken data signal transmission line, and the identification comprises a serial number of the shift register unit or an address of the shift register unit.

5. The display apparatus according to claim 4, wherein the repair module comprises at least one repair output circuit, at least one repair signal transmission line, and at least one repair signal connection line, and an extension direction of the repair signal transmission line intersects with an extension direction of the repair signal connection line, there is a one-to-one correspondence relationship between the repair signal transmission line and the repair signal connection line, and the extension direction of the repair signal transmission line is the same as the extension directions of the data signal transmission lines, the data processing circuit is configured to acquire the set of defect identifications stored in advance; determine whether an identification of a shift register unit by which image data is to be sent is located in the set of defect identifications stored in advance; when the identification of the shift register unit by which the image data is to be sent is not located in the set of defect identifications stored in advance, send the preprocessed image data to the shift register unit; and
when the identification of the shift register unit by which the image data is to be sent is located in the set of defect identifications stored in advance, send preprocessed repair image data to the repair output circuit, the repair image data being image data to be provided to a shift register unit connected to the broken data signal transmission line, the repair output circuit is respectively electrically connected to the data processing circuit and at least one repair signal transmission line, and is configured to, according to the preprocessed repair image data, generate a data signal to be sent to the data signal line connected to the broken data signal transmission line, the repair signal connection line is respectively electrically connected to a corresponding repair signal transmission line and the data signal line connected to the broken data signal transmission line, and different repair signal connection lines are connected to different data signal lines, and a number of repair signal transmission lines is greater than or equal to a number of broken data signal transmission lines.

6. The display apparatus according to claim 5, wherein the repair output circuit is disposed on the chip on film, the repair signal transmission line is disposed on the display panel and the chip on film, and the repair signal connection line is disposed on the display panel.

7. The display apparatus according to claim wherein the repair output circuit comprises a repair shift register, a repair data latch circuit, a repair level conversion circuit, a repair digital-to-analog conversion circuit, and a repair output buffer circuit, the repair shift register is electrically connected to the data processing circuit and is configured to sample and output the preprocessed repair image data to generate a first repair data signal, the repair data latch circuit is electrically connected to the repair shift register and is configured to latch the first repair data signal and output a second repair data signal, the repair level conversion circuit is electrically connected to the repair data latch circuit and is configured to convert the second repair data signal to a third repair data signal, a level of the third repair data signal is greater than a level of the second repair data signal, the repair digital-to-analog conversion circuit is configured to convert the third repair data signal into a data signal, the third repair data signal is a digital signal and the data signal is an analog signal, and the repair output buffer circuit is respectively electrically connected to the repair digital-to-analog conversion circuit and the repair signal transmission line, and is configured to send the data signal to the repair signal transmission line.

8. The display apparatus according to claim 7, wherein the repair signal connection line is laser-welded to the data signal line connected to the broken data signal transmission line.

9. The display apparatus according to claim 4, wherein the repair modulea comprises a plurality of repair control circuits, a selection circuit, a repair signal transmission line, a first repair signal connection line, and a second repair signal connection line, and an extension direction of the first repair signal connection line and an extension direction of the second repair signal connection line intersect respectively with an extension direction of the repair signal transmission line, and the extension direction of the repair signal transmission line is the same as the extension directions of the data signal transmission lines, the data processing circuit is configured to generate a control signal, the repair control circuits are electrically connected to the data processing circuit and the selection circuit, respectively, and are configured to generate repair control signals according to the control signal, the selection circuit is electrically connected to the signal output circuits, the repair control circuits, the data signal transmission lines, and the first repair signal connection line, respectively, and is configured to transmit data signals output by the signal output circuits to the data signal transmission lines or the first repair signal connection line under control of the repair control signals, the repair signal transmission line is electrically connected to the first repair signal connection line and the second repair signal connection line, respectively, and the second repair signal connection line is electrically connected to the data signal line connected to the broken data signal transmission line.

10. The display apparatus according to claim 9, wherein the repair control circuits, the selection circuit, and the first repair signal connection line are disposed on the chip on film, the repair signal transmission line is disposed on the display panel and the chip on film, and the second repair signal connection line is disposed on the display panel.

11. The display apparatus according to claim 9, wherein a number of the repair control circuits is the same as a number of the signal output circuits, and a repair control circuit of the plurality of repair control circuits comprises a control shift register and a control level conversion circuit, the selection circuit comprises a plurality of selection switches, and a selection switch of the plurality of selection switches comprises a control terminal, a first terminal, a second terminal, and a third terminal, the control shift register is electrically connected to the data processing circuit and the control level conversion circuit, respectively, and is configured to sample and output the control signal to generate an intermediate control signal, the control level conversion circuit is electrically connected to the control shift register and the selection circuit and is configured to convert the intermediate control signal to a repair control signal, and a level of the repair control signal is greater than a level of the intermediate control signal, and the control terminal of the selection switch is electrically connected to a connected control level conversion circuit, the first terminal of the selection switch is electrically connected to a connected signal output circuit, the second terminal of the selection switch is electrically connected to a connected data signal transmission line, and a third terminal of the selection switch is electrically connected to the first repair signal connection line.

12. The display apparatus according to claim 11, wherein the second repair signal connection line is laser-welded to the data signal line connected to the broken data signal transmission line.

13. The display apparatus according to claim 1, wherein the repair module comprises a plurality of repair signal connection lines, and extension directions of the repair signal connection lines intersect with the extension directions of the data signal lines,
a repair signal connection line of the plurality of repair signal connection lines is electrically connected to the data signal line connected to the broken data signal transmission line and a data signal line connected to a data signal transmission line adjacent to the broken data signal transmission line, and repair signal connection lines connected to different data signal transmission lines are different, and
a number of the repair signal connection lines is greater than or equal to a number of broken data signal transmission lines.

14. The display apparatus according to claim 13, wherein the repair module further comprises a switch circuit comprising a plurality of switches, and the plurality of switches and the plurality of repair signal connection lines are in a one-to-one correspondence, and
a switch of the plurality of switches is electrically connected to a corresponding repair signal connection line.

15. The display apparatus according to claim 13, wherein a repair signal trace is a metal trace,
the repair signal connection line is laser-welded to the data signal line connected to the broken data signal transmission line, and the repair signal connection line is laser-welded to the data signal line connected to the data signal transmission line adjacent to the broken data signal transmission line.

16. The display apparatus according to claim 7, wherein when the shift register comprises a plurality of shift register units and the repair shift register comprises a plurality of repair shift register units, the shift register units comprise a first shift register unit and a second shift register unit, polarities of the first shift register unit and the second shift register unit are opposite, the repair shift register units comprise a first repair shift register unit and a second repair shift register unit, polarities of the first repair shift register unit and the second repair shift register unit are opposite, and the polarity of the first shift register unit is the same as the polarity of the first repair shift register unit, and
the data processing circuit sequentially sends a plurality of image data to be transmitted to shift register units connected to broken data signal transmission lines to a plurality of repair shift register units, or sends image data to be transmitted to the first shift register unit connected to the broken data signal transmission line to the first repair shift register unit and sends image data to be transmitted to the second shift register unit connected to the broken data signal transmission line to the second repair shift register unit.

17. The display apparatus according to claim 2, further comprising a printed circuit board, wherein
the printed circuit board is electrically connected to the chip on film.

18. A control method for a display apparatus, configured to control the display apparatus according to claim 1, comprising:
providing, by a source drive circuit, a data signal to an unbroken data signal transmission line, and
providing, by a repair module, a data signal to a data signal line connected to a broken data signal transmission line.

19. The method according to claim 18, wherein the source driver comprises a data processing circuit and a plurality of shift register units, the repair module comprises a plurality of repair output circuits, and transmitting, by the repair module, the data signal to the data signal line connected to the broken data signal transmission line comprises:
acquiring, by the data processing circuit, a set of defect identifications stored in advance, wherein the set of defect identifications comprises an identification of a shift register unit electrically connected to the broken data signal transmission line, and the identification comprises a serial number of the shift register unit or an address of the shift register unit,
determining, by the data processing circuit, whether an identification of a shift register unit by which image data is to be sent is located in the set of defect identifications stored in advance; when the identification of the shift register unit by which the image data is to be sent is not located in the set of defective identifications stored in advance, sending, by the data processing circuit, preprocessed image data to the shift register unit; and when the identification of the shift register unit by which the image data is to be sent is located in the set of defect identifications stored in advance, sending, by the data processing circuit, preprocessed repair image data to a repair output circuit of the plurality of repair output circuits, wherein the repair image data is image data to be provided to a shift register unit connected to the broken data signal transmission line, and
generating, by the repair output circuit, according to the preprocessed repair image data, a data signal to be provided to the data signal line connected to the broken data signal transmission line, and providing the data signal to the data signal line connected to the broken data signal transmission line.

20. The display apparatus according to claim 6, wherein the repair output circuit comprises a repair shift register, a repair data latch circuit, a repair level conversion circuit, a repair digital-to-analog conversion circuit, and a repair output buffer circuit, the repair shift register is electrically connected to the data processing circuit and is configured to sample and output the preprocessed repair image data to generate a first repair data signal, the repair data latch circuit is electrically connected to the repair shift register and is configured to latch the first repair data signal and output a second repair data signal, the repair level conversion circuit is electrically connected to the repair data latch circuit and is configured to convert the second repair data signal to a third repair data signal, a level of the third repair data signal is greater than a level of the second repair data signal,
the repair digital-to-analog conversion circuit is configured to convert the third repair data signal into a data signal, the third repair data signal is a digital signal and the data signal is an analog signal, and
the repair output buffer circuit is respectively electrically connected to the repair digital-to-analog conversion circuit and the repair signal transmission line, and is configured to send the data signal to the repair signal transmission line.
